(19) United States
(12) Patent Application Publication
(10) Pub. No.: US 2011/0197005 A1
(43) Pub. Date: Aug. 11, 2011

(54) MOTHERBOARD EXPANSION DEVICE

(75) Inventors: TSUNG-KUEL LIAO, Tu-Cheng (TW); YI-CHENG TSENG, Tu-Cheng (TW); HSUAN-FU LEE, Tu-Cheng (TW)

(73) Assignee: HON HAI PRECISION INDUSTRY CO., LTD., Tu-Cheng (TW)

(21) Appl. No.: 12/892,397

(22) Filed: Sep. 28, 2010

(30) Foreign Application Priority Data
Feb. 9, 2010 (TW) 99104044

(51) Int. Cl. G06F 13/00

(52) U.S. Cl. 710/301

(57) ABSTRACT

A motherboard expansion device includes a motherboard having a expansion slot conforming a first standard, an expansion card conforming a second standard, a converter card positioned between the motherboard and the expansion card, and the converter card connects to the expansion slot and the expansion card, respectively; a converter chip is mounted on the converter card for converting signals between the expansion slot and the expansion card, and one or more motherboard components mounted on the motherboard. The expansion card is mounted vertically above the motherboard, and is supported by the converter card, and the converter card defines a cutout between the converter card and the motherboard to partially receive the motherboard component.

### BACKGROUND

1. Technical Field

The present disclosure generally relates to motherboards, and particularly to a motherboard expansion device used in a server system.

2. Description of Related Art

Electronic system motherboards are becoming increasingly integrated to support a growing number of features and/or more compact packaging. Typically, a motherboard includes a microprocessor, a co-processor (if any), a memory, a basic input/output system, and a plurality of expansion slots. Additional components can be coupled to a motherboard through its expansion slots. The expansion slots fit various expansion cards, such as an accelerated graphics port (AGP) expansion card, a peripheral component interconnect express (PCI-E) expansion card, and a PCI-X expansion cad. The expansion cards are plugged into the expansion slots perpendicular to the motherboard. However, the expansion card of relatively large dimensions can interfere with other components mounted on the motherboard, such as a CPU heat sink and a memory bank, thus a relatively large space is required for the expansion card, and less space is available for other components of the motherboard.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of a first embodiment of a motherboard expansion device.

FIG. 2 is an isometric view of a second embodiment of a motherboard expansion device.

### DETAILED DESCRIPTION

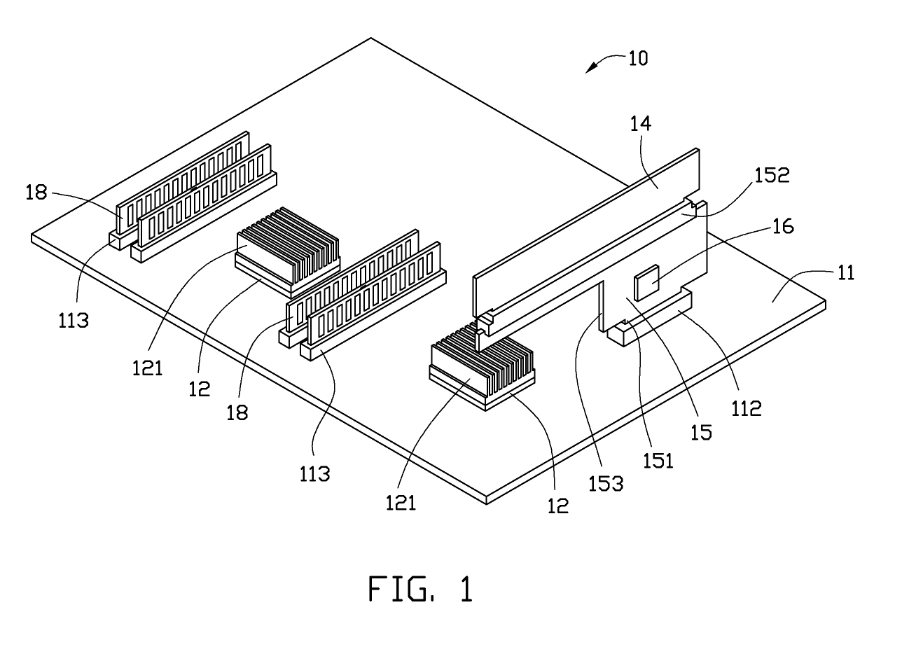

Referring to FIG. 1, a first embodiment of a motherboard expansion device 10 can be used in a server system. The motherboard expansion device 10 includes a motherboard 11 having an expansion slot 112 conforming and compatible with a first standard and several memory slots 113, two central processing units (CPUs) 12 mounted on the motherboard 11, an expansion card 14 conforming and compatible with a second standard, a converter card 15 positioned between the motherboard 11 and the expansion card 14, a converter chip 16 adapted to convert the signals between the expansion slot 112 and the expansion card 14, and several memory banks 18 plugged into the memory slots 113. Furthermore, a heat sink 121 may be mounted on a CPU 12 to dissipate heat. Other motherboard components of the motherboard expansion device 10, such as input and output units and display cards are not shown.

The memory slots 113 are parallel to each other. One CPU 12 is positioned between two adjacent memory slots 113, and the other CPU 12 is positioned between a memory slot 113 and one side of the motherboard 11. The expansion card 14 is positioned on one side of the motherboard 11 above the CPU 12 and the corresponding heat sink 121, and is parallel to the memory slots 113.

The converter card 15 includes a number of pins 151 formed on one side thereof, and also defines a connection slot 152 on the opposite side thereof. The pins 151 are received in the expansion slot 112, and the connection slot 152 is connected to the expansion card 14. The converter card 15 is perpendicular to the motherboard 11 and vertically supports the expansion card 14 in such a manner that the expansion card 14 is above the heat sink 121 mounted on the CPU 12.

The converter card 15 defines a receiving portion 153 between the converter card 15 and the motherboard 11 for at least partially receiving or accommodating the CPU 12 and the heat sink 121, thus the expansion card 14 can be positioned above the CPU 12 and the heat sink 121 without interference. Therefore, on the horizontal plane, no additional space is needed for the expansion card 14, and the motherboard expansion device 10 can achieve a more compact structure.

In the first embodiment, the receiving portion 153 is a cutout and is defined on one side of the converter card 15 adjacent to the CPU 12. The receiving portion 153 exceeds the height of the heat sink 121, so that the CPU 12 and the heat sink 121 are positioned underneath the top part of the receiving portion 153. The expansion slot 112 meets or conforms to the PCI-E standard, and the expansion card 14 meets or conforms to the PCI-X standard. The converter chip 16 is mounted on the converter card 15, and electrically connects the expansion slot 112 and the expansion card 14 and converts the signals therebetween. In other words, the converter card 15 is adapted to convert the signals meeting or conforming to the PCI-E standard to those meeting or conforming to the PCI-X standard, thus electrically connecting the expansion slot 112 and the expansion card 14. In one embodiment, the converter chip 16 can be a PXH-V converter chip from Intel.

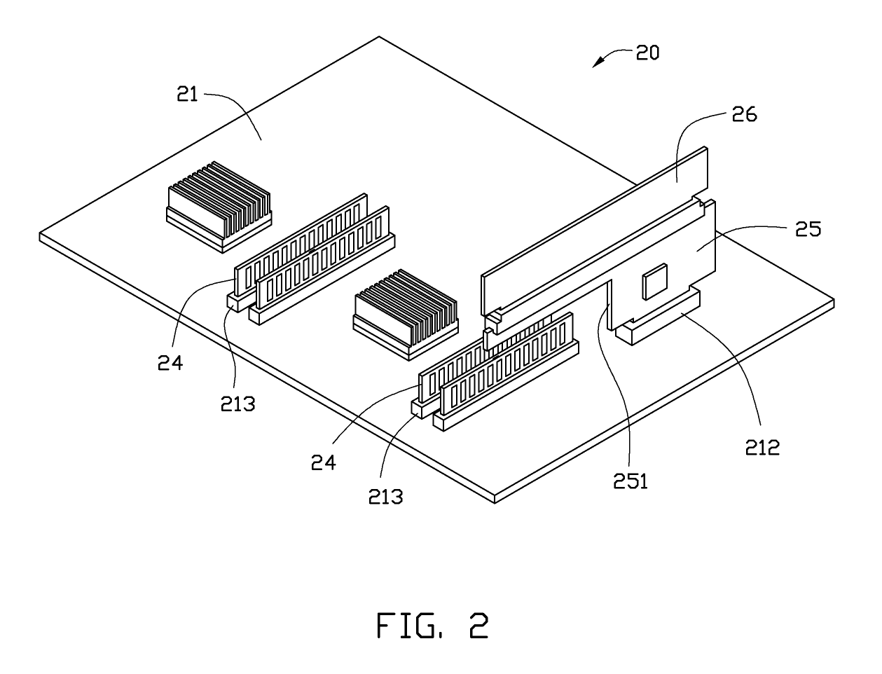

Referring to FIG. 2, a second embodiment of the motherboard expansion device 20 differs from the first embodiment only in that the expansion slot 212 is near and parallel to a memory slot 213. The cutout 251 is defined on a side of a converter card 25 adjacent to the memory slot 213. The cutout 251 exceeds the height of the memory bank 24, so that the memory bank 24 can be partially received or accommodated in the cutout 251 without interference. Therefore, an expansion card 26 can be easily mounted and no additional space in the horizontal direction is needed.

While the disclosure has been described in terms of several preferred embodiments, there are alternative permutations, and equivalents, which fall with the scope of this invention. For example, the expansion slot 112 can meet or conform to the PCI-X standard, and the expansion card 14 meets or conforms to the PCI-E standard. Furthermore, a plurality of expansion cards 14 may be used in the motherboard expansion device.

1. A motherboard expansion device comprising:
a motherboard defining an expansion slot, the expansion slot conforming to a first standard;
an expansion card conforming to a second standard;
a converter card positioned between the motherboard and the expansion card, and the converter card connecting the expansion slot and the expansion card;
a converter chip mounted on the converter card for converting one or more signals between the expansion slot and the expansion card; and
at least one motherboard component mounted on the motherboard;
wherein the expansion card is mounted vertically above the motherboard and supported by the converter card, and the converter card defines a cutout for at least partially receiving the at least one motherboard component.

2. The motherboard expansion device of claim 1, wherein the at least one motherboard component comprises a central processing unit, and the expansion card is positioned on one side of the motherboard above the central processing unit.

3. The motherboard expansion device of claim 2, further comprising a heat sink mounted on the central processing unit, and the expansion card is positioned above the heat sink.

4. The motherboard expansion device of claim 3, wherein the cutout is formed on a side of the converter card adjacent to the central processing unit.

5. The motherboard expansion device of claim 1, the motherboard defines one or more memory slots, and the motherboard expansion device further comprises one or more memory banks plugged into the memory slots, respectively, wherein one memory bank is partially received in the cutout.

6. The motherboard expansion device of claim 5, wherein the cutout is formed on a side of the converter card adjacent to the memory bank.

7. The motherboard expansion device of claim 1, wherein the first standard is a PCI-E standard, and the second standard is a PCI-X standard.

8. The motherboard expansion device of claim 1, wherein the first standard is a PCI-X standard, and the second standard is a PCI-E standard.

9. The motherboard expansion device of claim 1, wherein the converter card comprises a plurality of pins and a connection slot formed on opposite sides thereof, respectively.

10. The motherboard expansion device of claim 9, wherein the plurality of pins is received in the expansion slot, and the connection slot is connected to the expansion card.

11. A motherboard expansion device comprising:
a motherboard defining an expansion slot, the expansion slot conforming to a first standard;
an expansion card conforming to a second standard;
a converter card positioned between the motherboard and the expansion card, the converter card connecting the expansion slot and the expansion card; and
a converter chip mounted on the converter card for converting one or more signals between the expansion slot and the expansion card;
wherein the expansion card is mounted vertically above the motherboard and supported by the converter card, and the converter card defines a cutout between the converter card and the motherboard.

12. The motherboard expansion device of claim 11, wherein the first standard is a PCI-E standard, and the second standard is a PCI-X standard.

13. The motherboard expansion device of claim 11, wherein the converter card comprises a plurality of pins and a connection slot formed on opposite sides thereof.

14. The motherboard expansion device of claim 13, wherein the plurality of pins is received in the expansion slot, and the connection slot is connected to the expansion card.
